(19) United States
(12) Patent Application Publication
(10) Pub. No.: US 2026/0061416 A1
(43) Pub. Date: Mar. 5, 2026

(54) HOLDER FOR PIPETTES AND PIPETTING DEVICE COMPRISING A PIPETTING AID AND A HOLDER

(71) Applicant: INTEGRA Biosciences AG, Zizers (CH)

(72) Inventors: Christoph Philipp, Bad Ragaz (CH); Philipp Schatzer, Mels (CH); Andreas Gross, Chur (CH)

(21) Appl. No.: 19/315,502

(22) Filed: Aug. 30, 2025

(30) Foreign Application Priority Data
Sep. 2, 2024 (CH) CH000936/2024

(51) Int. Cl. B01L 3/02; B01L 9/00

(52) U.S. Cl. CPC B01L 3/0237; B01L 3/0275; B01L 9/54; B01L 2400/0481

(57) ABSTRACT

A receiving device for a pipette intended for the aspiration and dispensing of a liquid. The receiving device can be connected to a motorized pipetting aid or can be part of such a device. The receiving device includes a housing and a first retaining device in the form of an elastically deformable receiving body, into which the rear end of a pipette can be inserted in such a way that the pipette is retained on the receiving device by means of a friction fit. Furthermore, the receiving device is wherein a second retaining device in the form of a clamping device is provided in the housing, which allows pipette necks of different diameters to be clamped in place.

### CROSS-REFERENCE TO RELATED APPLICATIONS

This application claims priority to Swiss Patent Application No. CH000936/2024 filed Sep. 2, 2024, the disclosure of this application is expressly incorporated herein by reference in its entirety.

### TECHNICAL FIELD OF THE INVENTION

The invention relates to a receiving device for a pipette intended for the aspiration and dispensing of a liquid, with the features according to the independent claim, as well as a pipetting device with a pipetting aid and a receiving device.

### BACKGROUND OF THE INVENTION

The pipetting aid is a laboratory device that simplifies the dosing of liquids using a pipette. In its classic form, the pipette has an upper and a lower opening. The pipette is designed to receive a liquid through the lower opening and then deliver it. The dosing of a liquid through the lower opening of the pipette can be controlled by the volume flow at its upper opening. The volume removed from the upper opening of the pipette must be introduced through its lower opening, and vice versa. When using a pipetting aid, it is positioned at the upper opening of the pipette. The pipetting aid determines the volume flow at the upper opening, thereby simultaneously controlling the corresponding volume flow at the lower opening. The volume flow at the upper opening can influence the movement of the liquid inside the pipette. The fluid at the upper opening is usually air, which means that the pipetting aid determines the air flow through the upper opening in both directions. A pump may be provided in the pipetting aid for this purpose. The pump is usually activated by pressing a button on the pipetting aid. When activated, the pump creates a vacuum, causing the air in the pipette to flow out through the upper opening and creating a suction effect at the lower opening, which in turn introduces liquid into the pipette. The introduction of liquid into the pipette is also referred to as aspiration. The removal of liquid from the pipette is referred to as dispensing. A diaphragm pump is usually used as the pump. It is designed in such a way that it can deliver a predetermined mechanical output and, optionally, allows this mechanical output to be changed via an adjustment device. Apart from the use of an adjustment device, the pump therefore has only two operating states. Therefore, a digital control with a button to switch on the pump can be used for the pump. One disadvantage of using such a pump is that the pipetting aid has a lower delivery limit. This means that the volume flow for aspiration cannot increase continuously from zero but jumps to a minimum volume flow after pressing the button and starting the pump.

The pipetting aids commonly used today for laboratory pipettes usually have a receiving device 211 in which pipettes of different volumes can be tensioned. A pipette is introduced from below into a pipette holder 213, which has a receiving channel 215 with a cross-section that narrows from bottom to top. The pipette holder 213 must be designed in such a way that it can receive and secure pipettes with pipette tips of different diameters. The pipette holder usually consists of a cylindrical silicone block with a conical receiving channel 215 in the center. To tension a pipette, the rear end of the pipette is introduced into the receiving channel of the pipette holder, which narrows as the penetration depth increases, until the receiving channel is widened by the end of the pipette and the latter is finally enclosed so tightly by the elastic pipette holder material that the pipette is retained in the receiving device against its gravitational force.

The rear end of the continuous receiving channel 215 is connected to a hydrophobic filter 217, which ensures that aspirated liquid cannot enter the interior of the pipetting aid. If the pipette is accidentally overfilled and the filter becomes wet as a result, it must be replaced.

The design of the receiving devices currently in use provides for the hydrophobic filter 217 to be positioned vertically above the pipette holder 213. To ensure that the hydrophobic filter does not create significant resistance to gas flow, the filter must have a relatively large cross-sectional surface. This means that the cross-sectional surface of the filter corresponds to a multiple, usually more than twenty times, the cross-sectional surface of the filter's inlet and outlet conduits. Accordingly, ample space must be provided for the filter in the receiving device. The filter usually comprises a flat, closed cylindrical housing with the filter located in the center. There is a connection piece in the center of each of the two flat sides of the filter housing for connecting the inlet and outlet conduit of a gas flow. The filter housing is aligned perpendicular to the center axis of the pipette holder's receiving channel. The linear arrangement of the pipette holder and the filter requires a relatively tall housing to accommodate the components of the receiving device.

When a pipette is received in the receiving body, it is only retained at its upper end. However, due to the conical shape of the receiving channel, the pipette neck inevitably has some play below the tensioning position, meaning that the center axis of the pipette may deviate from the center axis of the receiving device. This means that, depending on how the operator retains the receiving device, the pipette can be at an angle to the center axis of the receiving device. While the upper end of the pipette is firmly tensioned, the pipette can pivot around the tensioning position due to the flexibility of the elastic receiving device. Ultimately, this means that the pipette holder does not provide a stable hold for the pipette, which can therefore swing back and forth when using the pipetting device. This is annoying because the pipette tip experiences the greatest deflection and its precise placement is very important when pipetting. The aforementioned oscillation of the pipette makes it considerably more difficult for the user to operate the pipetting aid. The deflection of a tensioned pipette can also be greater the more the diameter of the pipette neck differs from the average diameter of the receiving channel.

### TASK

It is therefore an object of the present invention to propose an improved receiving device for pipettes, which provides a better hold for pipettes so that no or only minimal pendulum motion is possible. Another objective is to provide a receiving device that is as compact as possible and has a low overall height. Another objective is to propose a receiving device that allows the presence of a pipette to be detected. Another objective is to propose a pipetting device that can prevent overfilling of the pipette.

### DESCRIPTION

The invention relates to a receiving device for a pipette for aspirating and dispensing a liquid, which can be connected to a motorized pipetting aid or is part of such an aid. Such a receiving device comprises a first retaining device for creating a force-fit connection with a pipette in such a way that the pipette is retained on the receiving device, wherein the first retaining device is a pipette holder in the form of an elastic receiving body into which the rear end of a pipette can be inserted in such a way that the pipette is retained in a receiving channel of the receiving device by means of a friction fit.

The receiving device according to the invention is further characterized in that a second receiving device in the form of a clamping device is provided along a center axis of the retaining device at a distance from the pipette holder. By providing two retaining devices arranged at a distance from each other, the rear end of a pipette can be secured in two places, which largely prevents a pipette inserted into the receiving device from swinging. When connecting a pipette to the receiving device, its rear end is guided through the clamping device and tensioned in the pipette holder. The pipette holder is primarily responsible for receiving the weight of the pipette, while the clamping device prevents the pipette from deflecting sideways, thus ensuring that it is retained securely in place. Like the pipette holder, the clamping device is also designed to receive different diameters. Pipette holders and clamping devices can usually receive pipette diameters between approximately 4 and 10 mm.

The advantageous embodiments listed below, either alone or in combination with each other, lead to further improvements in the receiving device according to the invention.

Preferably, the clamping device comprises movable clamping jaws which can be moved toward and away from each other perpendicular to the center axis in order to clamp a pipette neck from different directions. Such a design can be implemented cost-effectively and is hardly prone to malfunction.

It is advantageous to provide a passage opening between the clamping jaws of the clamping device, the width of which can assume all values between a first small diameter when the clamping jaws are preferably in contact, corresponding to an initial position, and a maximum second diameter. In the initial position, the passage opening can be 3 mm or even less. The smallest passage opening must be selected so that a clamping force is still achieved even with pipettes with the smallest diameter. This is achieved by appropriately preloading the springs, which means that the spring force is already effective in the initial state. Typically, the first diameter can be between 3.5 and 4 mm and the second diameter approximately 10 mm, e.g., 10.5 mm.

Preferably, the clamping device comprises at least two, but preferably at least three movable clamping jaws to prevent the pipette from breaking out to one side.

In a practical embodiment, the spring elements are compression springs that are supported at one end on the housing and interact with the clamping jaw at the other end. Such a design is simple and inexpensive to manufacture.

For practical reasons, the clamping jaws are radially preloaded inwards, i.e. into their initial position, by means of one or more spring elements. The spring elements can be implemented using springs or an elastic material that interacts with one or more clamping jaws.

Preferably, the clamping jaws have a slanted surface to allow pipettes of different diameters to be introduced. The slanted surfaces are chosen so that the passage opening forms a cone with a diameter of approx. 10 mm to 11 mm at the bottom and a diameter of between 3 and 4 mm at the top. It goes without saying that under these conditions, the clamping jaws must have a certain height so that the slanted surfaces can still be designed to be relatively steep, thereby keeping the resistance to overcoming the clamping jaws, which are preloaded in their initial position, low.

In a preferred embodiment, a filter arranged in a flat filter housing is arranged as a liquid barrier in the receiving device in the suction direction after the pipette holder. The filter's job is to protect the inside of the pipetting aid from liquid ingress.

Preferably, the filter housing is arranged essentially parallel to the center axis of the receiving device. This has the advantage that the receiving device can be designed to be much more compact than conventional pipette receiving devices.

Preferably, the pipette holder has a receiving channel that narrows from bottom to top and a corresponding connecting channel that serves to receive a connection piece of the filter. The connecting channel and the filter connection piece are preferably slightly conical in shape to facilitate attachment of the filter connection piece. In addition, the receiving channel has a groove structure to securely enclose the pipette ends.

In a preferred embodiment, the receiving channel and the connecting channel are arranged at an angle of approximately 90 degrees (e.g., 92 degrees) to each other. This enables a compact design of the receiving device.

In a preferred embodiment, the pipette holder comprises an elastic material. The elastic material can serve as a tensioning device due to its potential elastic deformation. The force-fit connection between the pipette holder and the pipette is thus achieved by the restoring force of the elastic material, which causes it to return to its original shape. The pipette holder is preferably made of silicone. Silicone is an elastic material that is highly resistant to many liquids and does not deliver any harmful substances that could contaminate the samples.

The receiving device is detachably attached to the pipetting aid. This allows the pipetting aid receiving device to be easily replaced. One advantage of this is that if the receiving device fails or becomes dirty, only the receiving device needs to be replaced. At the same time, multiple receiving devices can be provided for different conditions or applications, each of which can be operated with the same pipetting aid.

The subject matter of the present invention is also a pipetting device with a pipetting aid and a receiving device according to the invention.

In a preferred embodiment, a sensor is installed in the pipetting aid opposite the gap, which is designed to detect the presence or absence of a pipette and/or the presence of aspirated liquid in the monitored area of the pipette neck. This gives the pipetting device a functionality that known pipetting devices do not have.

Alternatively, a sensor can also be provided directly in the gap between the pipette holder and the clamping device. Placing the sensor close to the pipette neck enables reliable detection of a pipette or aspirated liquid.

The optional features mentioned can be implemented in any combination, provided they are not mutually exclusive. In particular, where preferred ranges are specified, further preferred ranges result from combinations of the minimums and maximums specified in the ranges.

The invention is described in more detail below with reference to the figures. The following is shown in the images:

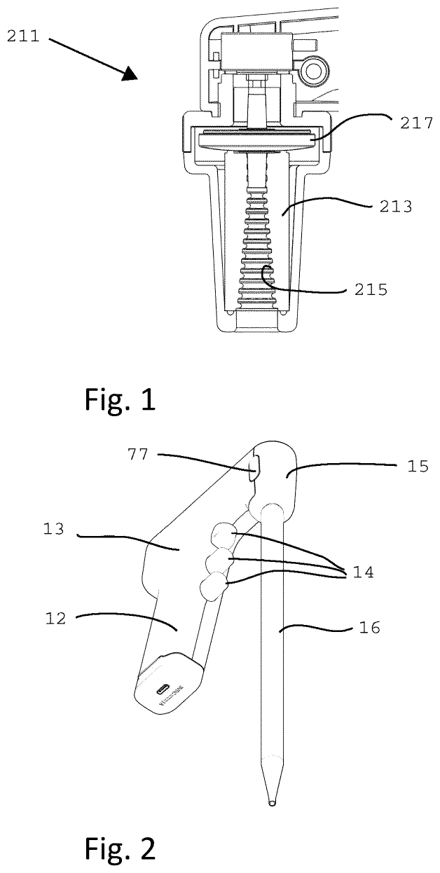

FIG. 1: a cross-section through a receiving device of a pipetting aid of the prior art

FIG. 2: a perspective view of a pipetting device consisting of a pipetting aid and a first embodiment of a pipette receiving device according to the invention;

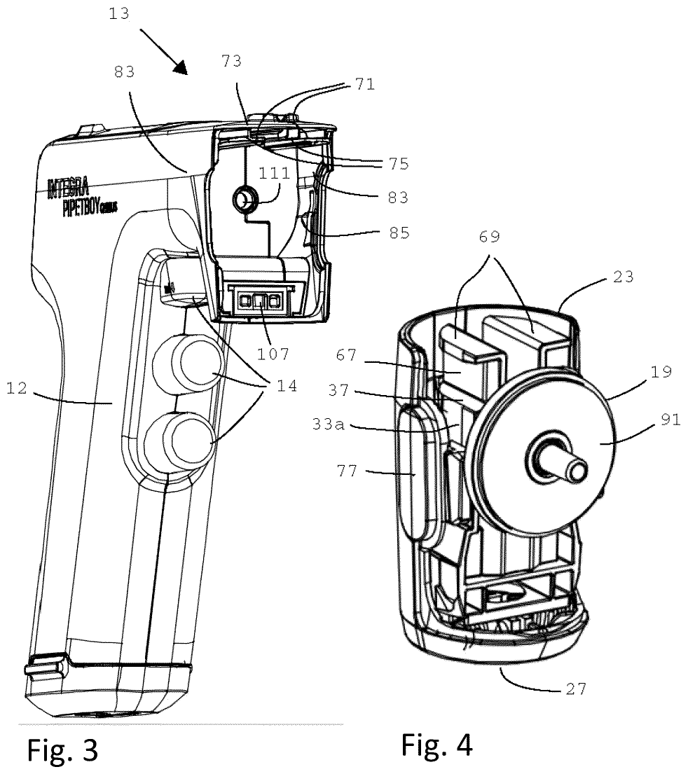

FIG. 3: a perspective view of only the pipetting aid from FIG. 2, in which the pipette receiving device has been removed;

FIG. 4: a perspective view of only the receiving device of FIG. 2 on an enlarged scale and matching the pipetting aid of FIG. 3;

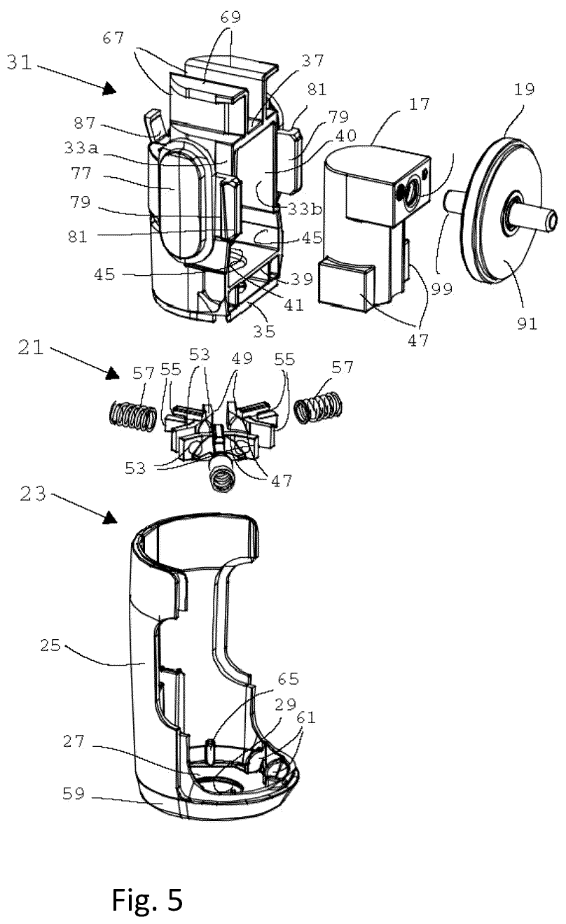

FIG. 5: an exploded view of the receiving device shown in FIG. 4;

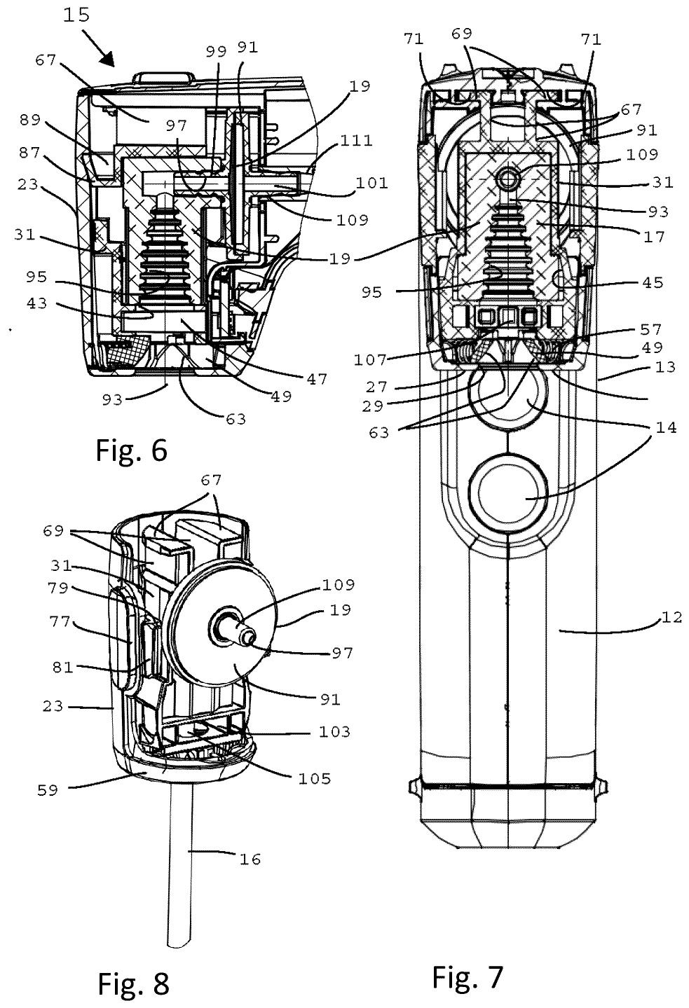

FIG. 6: a longitudinal section through the front part of a pipetting aid with a receiving device;

FIG. 7: a cross-section through the receiving device of FIG. 6 from the front;

FIG. 8: a perspective view of the inventive receiving device with pipette;

FIG. 9: a perspective view of a partially cutaway receiving device with a slightly modified design of the clamping blocks;

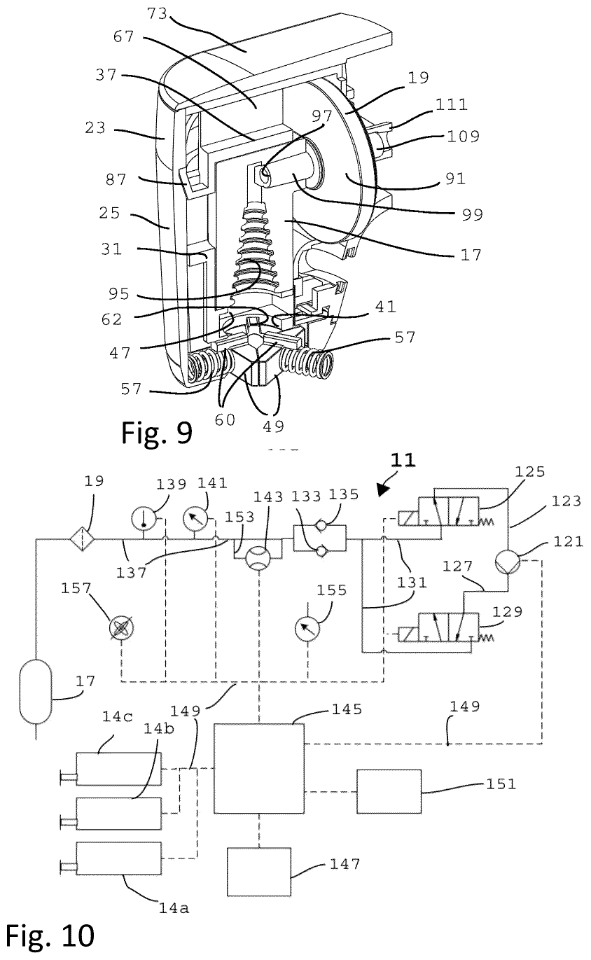

FIG. 10: a schematic representation of the components of the pipetting device, with the valves shown in the aspiration position;

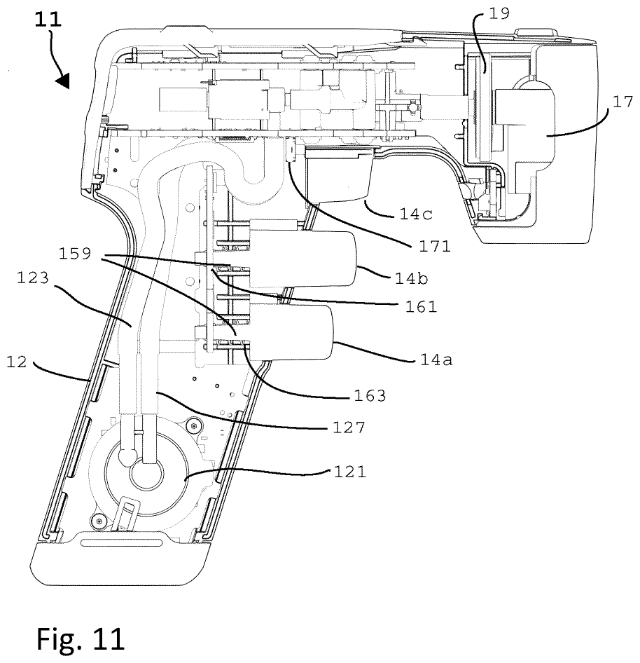

FIG. 11: a side view of the pipetting device with one half of the housing removed; and

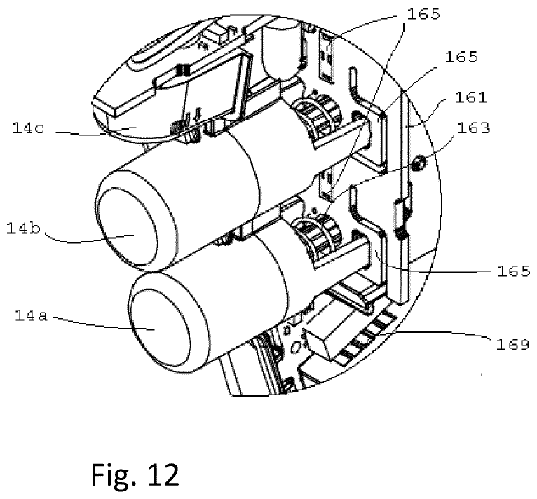

FIG. 12: The device for measuring the contact pressure of the control buttons on a strain gauge.

The receiving device 211 of a pipetting aid according to the current state of the art shown in FIG. 1 has already been described in the introduction to the description. Their main disadvantage is that pipettes received in the pipette holder are not retained securely and can swing back and forth during handling.

The pipetting device 11 shown in FIGS. 2 through 8 consists of a motor-driven pipetting aid 13 and a first embodiment of a pipette receiving device 15 according to the invention. In FIG. 2, a pipette 16 is received in the receiving device 15 for illustrative purposes. The pipetting aid 13 has a handle 12 and control buttons 14, which can be used to control the aspiration or dispensing of a liquid.

The essential components of the inventive receiving device 15 are a pipette holder 17, a filter 19 connected to it, and a clamping device 21, which provides additional support for a pipette received in the pipette holder 17. The aforementioned components of the receiving device 15 are received in housing 23, which comprises a roughly semicircular cylindrical shell 25 and a circular bottom 27 attached to it. The bottom 27 has a central circular opening 29 through which the rear end of a pipette, which in pipettes with larger volumes is a circular cylindrical neck with a tapered diameter, can be introduced into the pipette holder 17.

A headpiece 31, to which the housing 23 can also be attached, serves to receive the pipette holder 17 and at the same time as a connecting means to the pipetting aid 13. The headpiece 31 has a substantially rectangular frame with two side walls 33a, 33b, a bottom wall 35, and a top wall 37. An intermediate bottom wall 39 is located a short distance from the bottom wall 35. Space 41 between top wall 37 and intermediate bottom wall 39 serves to receive the pipette holder 17 precisely. A circular recess 41 is provided in the intermediate bottom wall 39, which may be slightly larger in diameter than the introduction opening 43 of the pipette holder 17 (FIG. 6). The side walls 33a, 33b have rectangular protrusions 45 adjacent to the intermediate bottom wall 39, which protrude outwards at the sides. These serve to receive retaining flanges 47 molded onto the base of the pipette holder 17 and protruding outward. This form-fit connection prevents the pipette holder 17 from slipping when a pipette is tensioned in place.

A novel feature of the described receiving device is that a pipette is retained not only by the pipette holder 17 alone, but also by an additional clamping device 21, which is arranged between the bottom 27 of the housing 23 and the bottom wall 35 of the headpiece 31. In the preferred exemplary embodiment shown, the clamping device 21 comprises three clamping jaws 49, each of which comprises a short straight central piece 51 and two wings 53 extending from the central piece 51 at an angle of approximately 120 degrees. Two parallel webs 55 are provided at the rear of the clamping jaws 53, spaced apart from each other, between which a spring 57 can be placed.

A circumferential, upwardly protruding edge 59 is formed on the periphery of the bottom 27 of the housing 23, from which pairs of spaced-apart, approximately quarter-circular walls 61 protrude in the radial direction, which cooperate with the webs 55 to delimit the clamping jaws 49 and the springs 57 arranged between the webs 55. The springs 57 preload the clamping jaws 49 in the radial direction so that they touch each other in the rest position.

To enable pipettes of different diameters to be introduced and clamped, the clamping jaws 49 feature a slanted surface 63 such that there is a large introduction opening at the bottom and a small outlet opening at the top, wherein the introduction opening can be approximately 10 mm and the outlet opening between 3 and 4 mm. This ensures easy introduction of pipettes without significant resistance and clamping of small-diameter pipettes up to 4 mm.

When assembled, the bottom wall 35 of the headpiece 31 rests on the walls 59 and additional spacers 65, so that there is space between the housing bottom 27 and the bottom wall 35 to receive the clamping device 21.

A latch or snap connection and a form-fit connection are provided for detachable connection of the headpiece 31 to the pipetting aid 13. To achieve the positive connection, two upside-down L-shaped webs are molded onto the top wall 37, with their short legs 69 oriented sideways toward the outside. The legs 69 fit into lateral insertion compartments 71 formed on the housing of the pipetting aid 13. In this case, lateral insertion compartments 71 are located between a housing cover 73 of the pipetting aid and two webs 75, which protrude inward from the inner wall of the housing at a short distance from the housing cover 73. There is a distance between the webs 75 oriented toward each other that is insignificantly greater than the distance between the two angular webs 67 of the headpiece 31.

The latching connection is achieved by two push buttons 77, which are arranged on the outside of the side walls 33a, 33b. The push buttons 77 are connected to L-shaped bolts 79, whose outward-facing legs 81 can engage in undercuts 85 in the pipetting aid, which are provided on the lateral housing walls 83. The push buttons 77 are each preloaded outward by spring means not shown in the figures. It is conceivable that the plastic part itself could be spring-loaded and that the push buttons 77 and the legs 81 could be arranged, for example, on a spring-loaded plastic beam. By pressing the push button, the bolts 79 can be moved inward far enough to release the latching connection between the receiving device 15 and the pipetting aid 13, allowing the pipette receiving device 15 to be removed from the pipetting aid 13.

The cross-sectional views in FIGS. 6 and 7 show the inner workings of the receiving device in greater detail. It can be seen that a hook 87 protruding forward is molded onto headpiece 31, which can form a positive connection with an angular piece 89 provided on the inside of the housing 23 in order to fasten the housing 23 to the headpiece 31.

According to a separate independent aspect of the invention, a compact design of the receiving device 15 is achieved by the fact that the flat filter housing 91 of the filter 19 is no longer arranged perpendicular to a center axis 93 of the receiving device 15, but parallel to it. This is achieved by arranging the pipette receiving channel 95 and the conduit section 97, which serves to receive a connection piece 99 of the filter 19, at a right angle to each other (FIG. 6). This arrangement has the advantage that filter 19 is easily accessible and no part of the housing needs to be unscrewed in order to replace the filter 19. It goes without saying that the conduit section 97 and the connection piece 99 are designed to be slightly conical and/or have sealing lips in order to ensure that filter 19 fits securely in the pipette holder 17 and to guarantee a gas-tight connection between the pipette holder 17 and the filter 19. Alternatively, or additionally, sealing lips can be provided to achieve a good seal.

A gap 103 can be provided between the intermediate bottom wall 39 and the bottom wall 35, where a section of the pipette neck 105 several millimeters long is exposed and visually accessible from the front or from the pipetting aid. A sensor 107 installed in the pipetting aid opposite the gap 103 can thus detect the presence of a pipette 16 marked accordingly on the pipette neck (FIGS. 7 and 8). In combination with a suitable marking on the pipette, e.g., barcode or similar, the pipette type (maximum filling volume) can be determined, for example.

FIG. 6 shows that, when the pipetting device is ready for operation, the second connection piece 109 of the filter housing 91 is inserted into an elastically deformable connecting piece 111 of the pipetting aid.

FIG. 9 shows a slightly modified second embodiment of a clamping device 21. This differs from the clamping device described above in that the clamping jaws 49 have a trapezoidal shape when viewed from above. An elongated guide strip 60 is provided on the upper side of each of the trapezoidal clamping jaws 49, which can interact with a guide groove 62 on the underside of the intermediate bottom wall in order to guide the clamping jaws 49 in the radial direction.

FIG. 10 shows a schematic representation of the components of a pipetting device. In the figure shown, the pneumatic conduits are represented by solid lines and the electrical conduits by dashed lines. The pipetting device 11 has a pump 121 which is connected on one side via a conduit 123 to a multi-way valve 125 and on the other side via a conduit 127 to a multi-way valve 129. The multi-way valves 125, 127 are connected to each other and also to two one-way valves 133, 135 via a conduit 131. It is conceivable that the two functions are combined in a single component. A conduit 137 leads from the one-way valves via filter 19 to the pipette holder 17. The one-way valve 135 opens automatically when air is sucked in, i.e., aspirated, and the one-way valve 133 opens when liquid is delivered, i.e. dispensed. FIG. 10 shows the multi-way valves 125, 129 in the aspiration position, i.e., the multi-way valve 125 is open and the multi-way valve 129 is closed, so that air is sucked in via the conduits 123, 131, and 137.

Sensors for measuring the physical properties of the air flowing through the conduit are installed in conduit 137. The sensors may be, for example, a temperature sensor 139, a pressure sensor 141, and a mass flow sensor 143.

A control unit 145 with a memory unit 147 is provided to control the multi-way valves 125, 129 and the pump 121. The control unit 145 is connected via control conduits 149 to the control buttons 14a, 14b, and 14c on the one hand, and to the multi-way valves 125, 129, and the pump 121 on the other. The motor for the pump and the control unit are powered by a rechargeable battery (not shown in the diagram). An interface 151 allows communication with the control unit 145. The interface may be, for example, a keyboard, a touch-sensitive display, or a wireless communication link.

As can be seen from the diagram in FIG. 10, the mass sensor 143 does not measure the volume flow directly in conduit 137, but in a bypass conduit 153. The volume flow in the bypass conduit is only a fraction, typically between 1 and 10 percent of the volume flow in conduit 137. This is what makes it possible to incorporate a gas flow sensor into a battery-powered hand pipetting device, as the gas flow sensors currently available for measuring a volume flow of up to 200 ml are simply too large to be integrated into a hand pipetting device.

In addition to the sensors already described above, the pipetting device 11 also has a second pressure sensor 155 for measuring the ambient pressure and an acceleration sensor 157. If the ambient pressure and the pressure in conduit 137 are known, the pressure difference can be taken into account when calculating the amount of liquid to be aspirated or dispensed using the general gas equation (P·V=n·R·T).

FIG. 11 shows the inner workings of the pipetting device 11 in more detail. The control buttons 14a and 14b are arranged on a printed circuit board 161 by means of a base 159. The control buttons 14a and 14b are movable perpendicular to the printed circuit board 161 and are preloaded into the rest position by a spring 163. The spring 163 is supported on a flexible shaft 165, on which a strain gauge 167 is arranged and firmly connected to the printed circuit board 161, e.g., via a solder connection (FIG. 12). The handle 12 also contains a rechargeable battery 169 for powering the electronics.

The pipetting device works as follows: FIG. 10 shows the aspiration position of the pipetting device. In this position, air is drawn in from the surroundings via conduit 123, multi-way valve 125, and conduits 131 and 137, and is delivered back into the surroundings via conduit 127 and multi-way valve 129.

If both multi-way valves 125, 129 are moved to the other position, the pump 121 sucks in ambient air via the multi-way valve 125 and the conduit 123 and transports it via the conduit 127, the multi-way valve 129, the conduit 131, and the one-way valve 133 and the conduit 137 into a pipette 17 received in the pipette holder 17 (dispensation).

The control buttons 14a, 14b, and 14c can be used to perform aspiration (e.g., control button 14a), dispensing (e.g., control button 14b), or the metered delivery of a specific amount of liquid (e.g., control button 14c). Unlike control buttons 14a and 14b, control button 14c is only connected to a simple on/off switch 171. When switch 171 is pressed, a quantity of liquid previously entered via the interface or stored in a memory is dispensed.

The built-in sensors (mass or volume flow and pressure sensor and optional temperature sensor) are used to calculate the amount of liquid aspirated. With additional knowledge of the specific gravity of the liquid, the aspirated or dispensed liquid volume can be precisely calculated and adjusted. The existing acceleration sensor can also be used to take into account the tilt of the pipette (deviation of the pipette's longitudinal axis from the vertical) and changes in the weight of the liquid. To achieve high accuracy, it is advantageous to calibrate the pipetting device with the flow sensor using an external, calibrated flow sensor. For liquids with viscosity and density different from water, a correction factor can be determined by the user.

Summary: The invention relates to receiving device 15 for a pipette intended for the aspiration and dispensing of a liquid. The receiving device 15 can be connected to a motor-driven pipetting aid 13 or can be part of such a device. The receiving device 15 comprises a housing 23 and a first retaining device in the form of an elastically deformable receiving body 15, into which the rear end of a pipette 16 can be inserted in such a way that the pipette is retained on the receiving device 15 by means of a friction fit. Furthermore, receiving device 15 is characterized in that a second retaining device in the form of a clamping device 21 is provided in the housing 23, which allows pipette necks of different diameters to be clamped in place.

### REFERENCE LIST

11 pipetting device
12 handle
13 pipetting aid
14 control buttons
15 receiving device for pipettes
16 pipette
17 pipette holder
19 filter
21 clamping device
23 housing
25 cylinder shell
27 bottom
29 opening of the bottom
31 headpiece
33a, 33b side walls
35 bottom wall
37 top wall
39 intermediate bottom wall
40 space for receiving the pipette holder
41 recess
43 introduction opening of the pipette holder
45 protrusion in side walls 33a, 33b
47 retaining flanges
49 clamping jaws
51 central piece
53 wings
55 webs
57 spring
59 edge
60 guide strip
61 walls
62 guide groove
63 slanted surface of the clamping jaws
65 spacer
67 L-shaped webs
69 leg
71 insertion compartments
73 housing cover
75 webs
77 push buttons
79 bolt
81 leg
83 side housing wall
85 undercut
87 hook
89 angular piece
91 filter housing
93 center axis
95 pipette receiving channel
97 conduit section
99 first connection piece
101 longitudinal axis
103 space between the false bottom wall and the housing bottom
105 pipette neck
107 sensor
109 second connection piece
111 connecting piece
121 pump
123, 127, conduits
131, 137
125, 129 multi-way valves
133,135 one-way valves
139 temperature sensor
141 first pressure sensor
143 mass sensor
145 control unit
147 data storage
149 control conduits
151 interface
153 bypass conduit
155 second pressure sensor
157 acceleration sensor
159 base of the control buttons
161 printed circuit board
163 spring
165 flexible shaft
167 strain gauges
169 battery
171 switch

1.-15. (canceled)

16. A receiving device for a pipette intended for the aspiration and dispensing of a liquid, comprising:
a housing,
a first retaining device in the form of a pipette holder arranged in the housing, into which a rear end of a pipette can be inserted in such a way that the pipette is retained in a receiving channel of the receiving device by means of a friction fit, wherein
a second retaining device in the form of a clamping device is provided in the housing and the receiving device is provided as a separate unit that can be detachably attached to a pipetting aid, wherein the first and second retaining devices are retained firmly in the receiving device in the detached state of the receiving device from the pipetting aid.

17. The receiving device according to claim 16, wherein the clamping device comprises movable clamping jaws which can be moved toward and away from each other perpendicular to the center axis.

18. The receiving device according to claim 16, wherein a through-opening is provided between the clamping jaws of the clamping device, the width of which can assume all values between a first small diameter when the clamping jaws are in contact (initial position) and a maximum second diameter, wherein the first diameter is approximately 3.5 and 4 mm and the second diameter is approximately 10 mm.

19. The receiving device according to claim 17, wherein the clamping device comprises at least two movable clamping jaws.

20. The receiving device according to claim 17, wherein the clamping jaws are radially preloaded inwardly by means of one or more spring elements.

21. The receiving device according to claim 20, wherein the spring elements are compression springs which are supported at a first end on the housing and are connected at the second end to the clamping jaw.

22. The receiving device according to claim 17, wherein the clamping jaws have a slanted surface to allow pipette necks of different diameters to be introduced.

23. The receiving device according to claim 16, wherein the housing comprises a cylindrical shell and a bottom arranged thereon, wherein the bottom comprises a central circular opening through which the rear end of the pipette can be introduced into the pipette holder.

24. The receiving device according to claim 16, wherein the receiving device comprises a headpiece that provides for receiving and securing the pipette holder and the clamping device, wherein the headpiece is configured to serve as a connecting means to the pipetting aid.

25. The receiving device according to claim 23, wherein the headpiece has a bottom wall and a top wall, wherein the pipette holder is arranged and secured between the bottom wall and the top wall, and the clamping device, with the housing fixed to the headpiece, is arranged and secured between the bottom of the housing and the bottom wall of the headpiece, wherein the headpiece further comprises an intermediate bottom wall arranged between the bottom wall and the top wall, and wherein a space between the top wall and the intermediate bottom wall is configured for precisely receiving and securing the pipette holder.

26. The receiving device according to claim 16, wherein a filter arranged in a flat filter housing is arranged as a liquid barrier in the receiving device in the suction direction after the pipette holder, wherein the filter housing is arranged essentially parallel to the center axis of the receiving device.

27. The receiving device according to claim 16, wherein the pipette holder has a receiving channel that narrows from bottom to top and a corresponding conduit section that serves to receive a connection piece of the filter, wherein the receiving channel and the conduit section leading to the filter are arranged at an angle of approximately 90 degrees to each other.

28. The receiving device according to claim 16, wherein the pipette holder is arranged downstream of the clamping device when viewed in the suction direction.

29. A pipetting device with a pipetting aid and a receiving device for a pipette intended for aspiration and dispensing of a liquid, comprising:
a housing,
a first retaining device in the form of a pipette holder arranged in the housing, into which a rear end of a pipette can be inserted in such a way that the pipette is retained in a receiving channel of the receiving device by means of a friction fit, and
a second retaining device in the form of a clamping device provided in the housing and the receiving device is provided as a separate unit that can be detachably attached to a pipetting aid, wherein
the first and second retaining devices are retained in the receiving device in a detached state of the receiving device from the pipetting aid.

30. The pipetting device according to claim 29, wherein a sensor is installed in the pipetting aid opposite a gap between the pipette holder and the clamping device, which sensor is designed to detect the presence or absence of a pipette.
